(19) United States
(12) Patent Application Publication
(10) Pub. No.: US 2024/0351149 A1
(43) Pub. Date: Oct. 24, 2024

(54) HOLDER WITH A SECURING MEANS FOR RELEASABLY SECURING A HAND-HELD TORCH, AND A HAND-HELD TORCH HAVING A HOLDER

(71) Applicant: Alexander Binzel Schweisstechnik GmbH & Co. KG, Buseck (DE)

(72) Inventors: Dimitri BELAN, Hungen (DE); Thomas SCHERER, Buseck (DE); Frank MÜLLER, Dannenfels (DE); Wolfgang LENSCH, Lahnau (DE)

(73) Assignee: Alexander Binzel Schweisstechnik GmbH & Co. KG, Buseck (DE)

(21) Appl. No.: 18/683,906

(22) PCT Filed: Aug. 30, 2022
(86) PCT No.: PCT/EP2022/074046

§ 371 Date: Feb. 15, 2024

(30) Foreign Application Priority Data
Sep. 3, 2021 (DE) 10 2021 122 844.1

(51) Int. Cl. B23K 37/02

(52) U.S. Cl. CPC B23K 37/0241

(57) ABSTRACT

The invention relates to a holder (10) with a securing means (1) for releasably securing a hand-held torch (5), the securing means (1) having at least in regions a negative form (2) of the hand-held torch (5) for reproducibly positioning the hand-held torch (5) in the holder (10), and the securing means (1) being adapted, at least in regions, to the outer contour (3) of the hand-held torch (5) when the hand-held torch (5) is secured. The invention further relates a hand-held torch (5) having a holder (10).

### CROSS-REFERENCE TO RELATED APPLICATIONS

This application is a national stage application (under 35 USC § 371) of PCT/EP2022/074046, filed Aug. 30, 2022, which claims benefit of DE 102021122844.1, filed Sep. 3, 2021, the contents of each of which is incorporated by reference herein.

### BACKGROUND OF THE INVENTION

### Technical Field and State of the Art

A The invention relates to a holder with a securing means for releasably securing a hand-held torch.

The invention also relates to a hand-held torch with a holder.

Thermal joining methods use energy to melt and join workpieces. “MIG”, “MAG”, and “WIG” welding is routinely used for sheet metal fabrication.

In inert gas-supported arc welding methods with melting electrode (MSG), “MIG” is short for “Metal Inert Gas”, and “MAG” is short for “Metal Active Gas”. In inert gas-supported arc welding methods with non-melting electrode (WSG), “TIG” is short for “Tungsten Inert Gas”. The welding torches according to the invention are manually guided torches, also known as manual welding or cutting torches or hand-held torches for short. However, machine-guided welding torches are also known, which are arranged on a robot arm. For this purpose, hand-held torches can be attached to the robot arm using a holder.

Welding machines with hand-held torches are also well known. There are different versions of these hand-held torches for controlling the welding parameters or entering the respective welding parameters on the hand-held torch.

DE 2020 171 017 08 U1 discloses a manual welding torch for a welding device with an input device for setting the welding parameters.

A manual welding torch with an input device with two separate buttons is known from the publication EP 1047521 A1, wherein one button is responsible for increasing and one button for decreasing a welding parameter shown on a display.

Furthermore, publication EP 2301704 A2 shows an embodiment of a manual welding torch with an input device that has a movable button that acts on four actuators, which in turn generate the corresponding signals. These four actuators are designed as mechanical or optoelectrical components, for example.

The use of such hand-held torches is widespread in the field of hard automation, for example, as the start and end sections of the weld seam have to be welded by hand, particularly when using a welding tractor.

Hard automation is when components such as automatic carriers, rotary tables or positioners are used in welding methods that enable welding without manual intervention but without robots. This mechanized or fully mechanized welding is a smart solution for efficiently designing recurring and standardized welding processes. With supporting tools such as welding tractors or automated torch guidance, simple processes become reliable and therefore process-safe. Complex and time-consuming reworking is eliminated or reduced to a minimum with hard automation.

In contrast to the fully automated welding or cutting process, hard automation supports the welder with one-sided work and therefore one-sided loads. Welding tractors can prevent the welder from adopting a forced posture when welding very long seams over a long period of time. The welding tractor ensures that several meters can be welded in one piece. The weld seam has the same quality throughout and no longer needs to be reworked.

Hand-held torches for semi-automated applications are clamped on the mostly curved torch neck. Clamping in this way causes damage to the torch neck, as a high clamping force is required to secure the torch against twisting.

After removing the hand-held torch, it must be completely realigned on the torch neck when reclamping, as the position that was set before unclamping cannot be easily reproduced. This means that time is lost each time the torch is reclamped on the torch neck of a hand-held torch. The exact reproduction of the previous positioning is very time-consuming or even impossible, especially with regard to the angle of twist, as there is no stop on a pipe bend of the torch neck to ensure a clear and reproducible position of the hand-held torch.

Torches clamped on the torch neck are not protected against unintentional actuation of a control element for operating the hand-held torch, for example a button. This can lead to operating errors, especially when the torch needs to be repositioned, as the user grips the hand-held torch by the handle.

In the case of clamped hand-held torches with interchangeable neck, the torch neck cannot be changed when the torch is clamped, as the torch is held on the torch neck.

Instead of clamping a hand-held torch on a pipe bend, automatic torches with an appropriate handle tube and straight neck can be used.

The use of hand-held torches with curved necks is widespread and the problems described above are often accepted. The use of hand-held torches with straight necks is unusual. As a rule, automatic torches cannot be used for manual welding, although this is often necessary.

Based on the disadvantages described above, the invention is based on the task of realizing a reproducible and torsion-proof positioning of a hand-held torch. Furthermore, it is the task of the invention to provide a switch-on protection against manual misuse for a hand-held torch.

### SUMMARY OF THE INVENTION

The invention relates to a holder with a securing means for releasably securing a hand welding or hand-held cutting torch, or hand-held torch for short, wherein the securing means for reproducibly positioning of the hand-held torch in the holder has a negative form of the hand-held torch at least in regions and the securing means are adapted to the outer contour of the hand-held torch at least in regions when the hand-held torch is secured.

For the purposes of the invention, the negative form of the hand-held torch is to be understood as the form which, at least in regions, fits essentially exactly to the outer form of the hand-held torch, similar to a negative form in the field of casting and molding technology.

Due to the negative form of the hand-held torch, reproducibly positioning of the hand-held torch, in particular anti-twist protection, is realized for temporary automated applications. This is because the user can set the position of the hand-held torch, remove the hand-held torch and then reinsert the torch in the exact position that was previously set without having to set it up again. Due to the negative form, the exact position of the hand-held torch is fixed with regard to the angle of rotation.

Overall, the design of the holder ensures exact reproducibility of the torch position.

In addition, there is a further advantage, particularly with hard automation. This is because the torque that the oscillator of the welding tractor, for example, has to apply to move the torch is smaller, as the lever of the main load hosepack to axis of rotation on the handle shell is shorter compared to the torch neck than when the torch is held on the torch neck.

According to a first advantageous embodiment, the negative form of the at least one securing means is adapted to a handle of the hand-held torch. The hand-held torch is secured to the handle of the torch using the holder and not to the neck of the torch. This makes it possible to change the torch neck on torches with interchangeable necks when the hand-held torch is mounted or secured. Clamping on the-curved-hand-held torch neck is superfluous. This prevents damage to the torch neck.

In addition, the reproduction of the position of the hand-held torch is also ensured by the exact handle shell receptacle in the hand-held torch holder. As mentioned, the user can position the hand-held torch, remove it from this position and then reinsert it in exactly the same position without having to set it up again.

The holder can therefore be clamped reliably and precisely onto the handle shell of the hand-held torch, as the securing means mold the exact negative form of the handle, in particular the handle shell, in the holder.

According to an advantageous embodiment of the invention, the securing means is formed from at least two sub-elements, in particular from two half-shells which can be attached to the manual welding torch, at least one sub-element in each case having a part of the negative form of the manual welding torch.

It is conceivable that only one sub-element has a negative form of the hand-held torch and the other sub-element has any shape, for example a curved or flat surface. This alone enables the hand-held torch to be clamped in position accurately and reproducibly. Of course, both sub-elements can also each have a corresponding negative form of the hand-held torch, which can further improve the hold of the hand-held torch.

The half shells of the holder ensure easy installation and interchangeability of the securing means. In this way, a single holder can be used in which securing means adapted to different hand-held torch shapes, i.e., half-shells for securing the hand-held torch, are inserted.

In a further development of the invention, it is provided that, when the hand-held torch is secured, an operating element or at least one button of the hand-held torch is covered at least in regions to prevent unintentional operation.

In particular, it can be provided that the operating element or at least one button of the hand-held torch is covered by the holder or the securing means or the closure or the receptacle.

In addition to the reproducibly securing of the hand-held torch, the holder according to the invention has further significant properties and advantages. This is because when the hand-held torch is mounted in the holder, at least one button on the hand-held torch is covered to prevent unintentional operation of parts of the holder. It does not matter whether the operating elements or buttons are located on the top and/or bottom of the hand-held torch.

In this way, switch-on protection is implemented to protect against manual misuse, as the hand-held torch holder the hand burner in the area of the hand-held torch button. This means that the operator has to grip the burner further back on the handle shell when inserting it into the holder and thus cannot unintentionally trigger operating errors by hand when inserting it into the holder. Once inserted into the holder, the torch button is protected against unintentional triggering. This means that the operator cannot trigger any operating errors, even when setting up the position.

According to a further advantageous embodiment of the invention, at least one sub-element of the securing means has an anti-rotation device, in particular at least one projection, in particular a pin, projecting from the surface of the sub-element of the securing means is provided, which engages in a corresponding recess on the hand-held torch when the sub-element is arranged on the hand-held torch.

Known hand-held torches can have recesses, in particular in the area of the handle shells of the handle, for example receptacles for fastening elements such as screws or rivets for connecting the handle shells of the hand-held torch to each other or to other parts of the hand-held torch. These existing recesses, for example holes, can be used to accommodate an appropriately designed projection, in particular a pin or positioning pin. This further improves the securing and also the accuracy of the positioning of the hand-held torch in the holder. Due to the negative form of the holder in relation to the handle, in particular to the handle shell of the handle and the positioning pins, the exact position of the hand-held torch is fixed with regard to the angle of rotation.

According to a further advantageous variant of the invention, the sub-elements are each held in a receptacle of the holder. It is particularly advantageous that, when the securing means are arranged with the sub-elements on the manual welding torch, the receptacles for the sub-elements can be releasably connected to each other or secured in the closed position by means of a snap-in connection or a screw connection or a closure, for example a snap-on or butterfly closure.

The receptacles can be connected to each other by means of a hinge so that they can be adjusted between the open position and the closed position. In the open position, the holder can be placed on the hand-held torch and then moved into the closed position to secure it. This adjustment can be easily realized with the hinge. The hinge can be realized, for example, by a pin forming the pivot or swivel axis, such as a plug-in pin, which can be inserted into corresponding hinge elements of the receptacles with through holes to form the hinge. The hinge can therefore be a simple plug-in connection. As mentioned, the two receptacles can be connected or secured together in the closed position by means of the closure.

This simplifies the assembly process. In addition, it is easy to replace the sub-elements. As mentioned, the sub-elements can be adapted to different types of hand-held torches. Depending on the use of a hand-held torch in the holder, the sub-elements can be held in the holder with the appropriate negative form and fixed in place using the snap-in or screw connection or the closure.

According to a further advantageous embodiment of the invention, the sub-elements consist essentially of plastic and/or metals. These can be self-hardening modeling compounds, for example. They can also be manufactured by injection molding or machining from plastics or metals.

For example, it is advantageous to use materials with shape memory, in particular self-hardening materials, to produce the negative form. These materials can be used to easily produce a variety of sub-elements, each of which is suitable for a specific hand-held torch. This ensures a high degree of flexibility in the use of different manual torches with very precise securing at the same time.

An independent idea of the invention relates to a hand-held torch with a holder as described above.

In a further advantageous variant of the invention, it is provided that the hand-held torch, in particular the handle of the hand-held torch, is designed to be non-rotationally symmetrical. This further improves the reproducibility of the position of the hand-held torch in the holder. The hand-held torches, in particular the handle of the hand-held torch, are usually non-rotationally symmetrical.

Further objectives, advantages, features, and applications of the present invention are derived from the subsequent description of an exemplary embodiment by way of the drawings. All described and/or depicted features, per se or in any combination, constitute the subject-matter of the present invention, regardless of their summary in the patent claims or their back-reference.

### DESCRIPTION OF THE DRAWINGS

Partially schematically, the drawings show:

FIG. 1 an exploded view of a holder for a hand-held torch,

FIG. 2 an exploded view of the holder according to FIG. 1 in a further view,

FIG. 3 the holder arranged on the hand-held torch in a) closed position and b) open position,

FIG. 4 further views of the holder arranged on the hand-held torch in a) closed position and b) open position as shown in FIG. 3,

FIG. 5 the holder with a positioning pin in a) closed position and b) open position and without positioning pin in c) closed position and d) open position,

FIG. 6 an exploded view of the holder with positioning pin a) and without positioning pin b),

FIG. 7 an exploded view of the holder according to FIG. 1 in a further view and

FIG. 8 a detailed view of the holder with positioning pin.

Identical or identically functioning components are provided with reference numerals based on an embodiment in the subsequently depicted figures of the illustration in order to improve readability.

### DETAILED DESCRIPTION

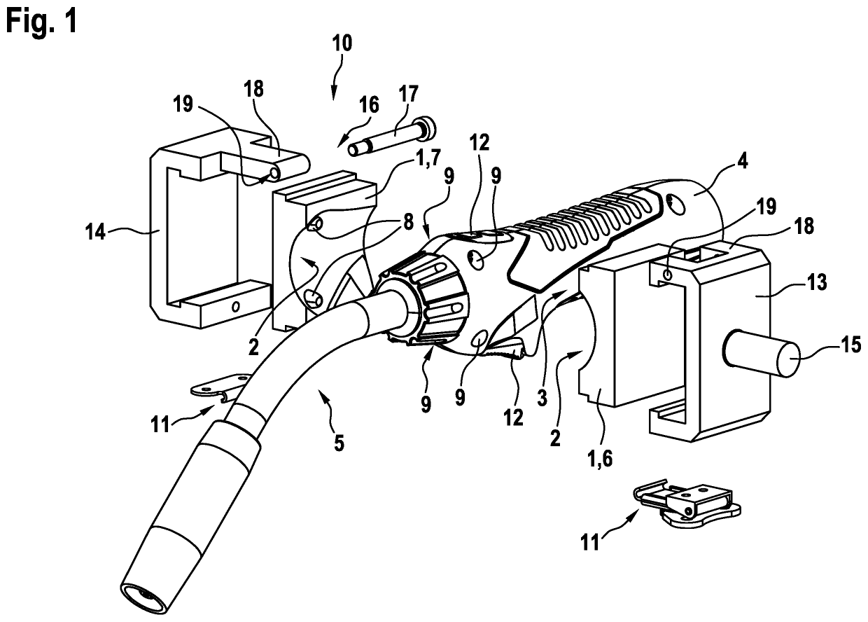

FIG. 1 shows an exploded view of a holder 10 with a securing means 1 for releasably securing a manual welding or manual cutting torch, or hand-held torch 5 for short.

For reproducibly positioning of the hand-held torch 5 in the holder 10, the securing means 1 has a negative form 2 of the hand-held torch 5, at least in regions. For the purposes of the invention, a negative form 2 is to be understood as the form that fits the outer shape of the hand-held torch 5 essentially exactly, at least in regions. In this way, the securing means 1 are at least in regions adapted to the outer contour 3 of the hand-held torch 5 when the hand-held torch 5 is secured.

FIGS. 1, 2, 3, 4, 7, and 8 each show a known hand-held torch 5, which has a torch neck and a handle 4, which in the present case can be formed from handle shells.

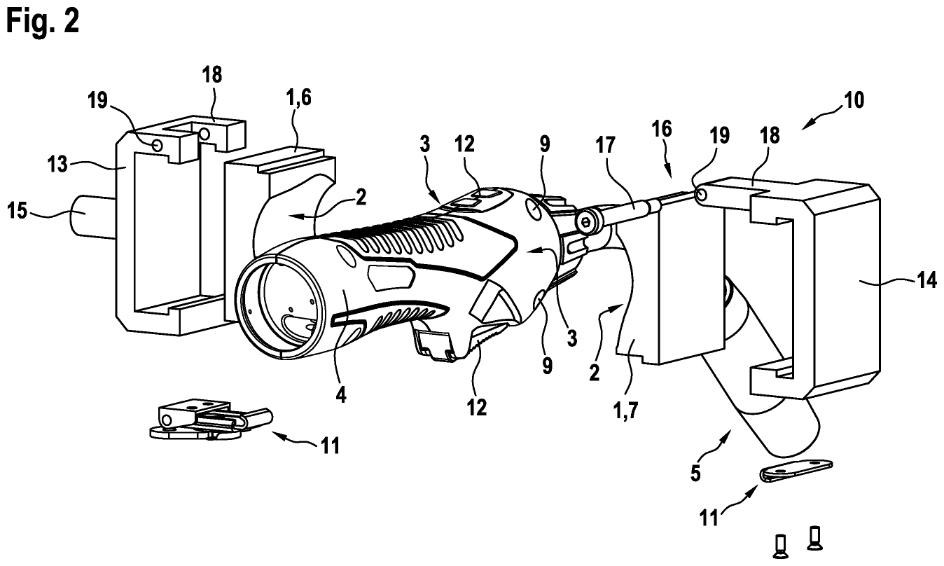

The figures differ firstly in the design of the holder and secondly in the view of the illustration. FIG. 1 then shows an exploded view of the holder with a positioning pin 8 and a generic hand-held torch 5 in a first view and FIG. 2 shows the holder with hand-held torch 5 in a further view, but in an embodiment without positioning pin 8.

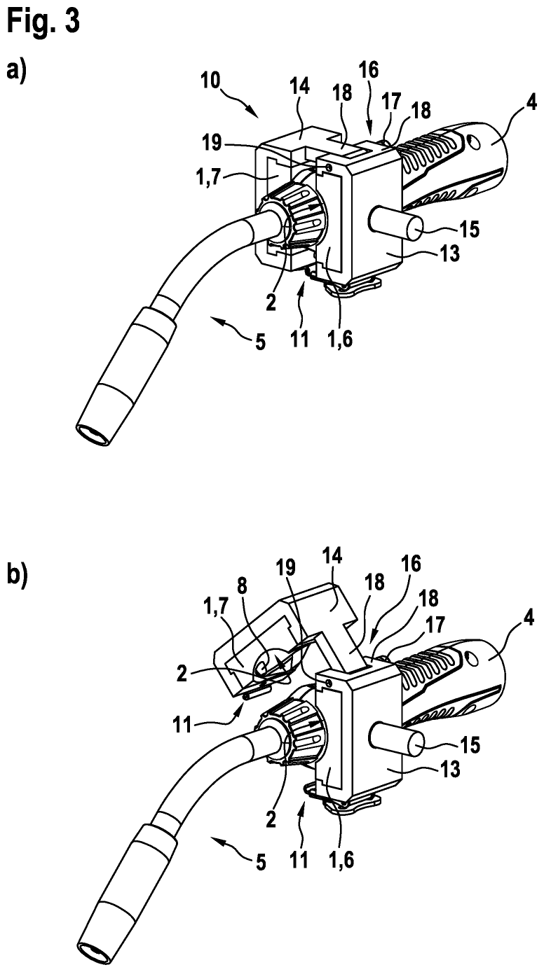

FIG. 3 shows the holder 10 with the hand-held torch 5 attached to it in a) closed position and b) open position. This embodiment also has the positioning pins 8.

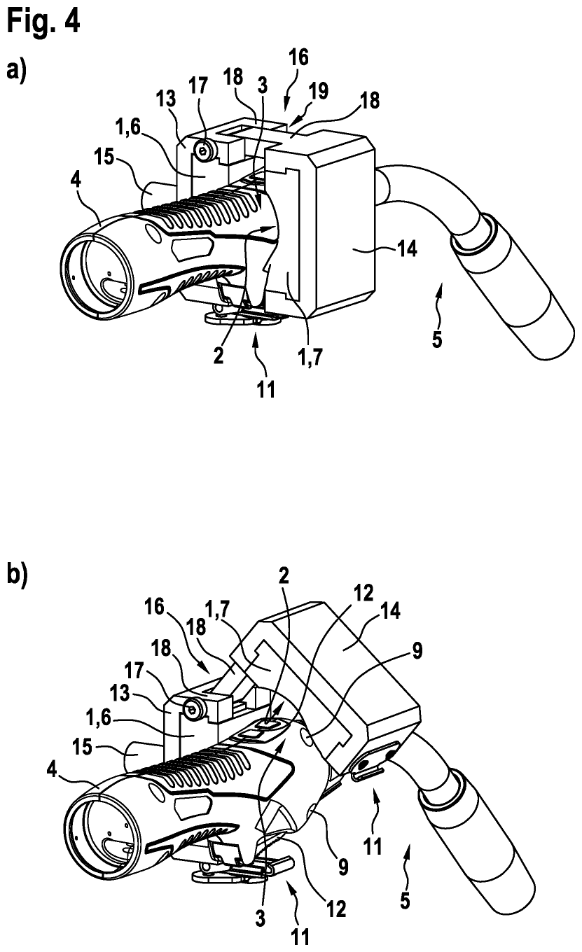

FIGS. 4 a) and b) correspond to the embodiment shown in FIG. 3, but show the holder 10 with hand-held torch 5 from the rear.

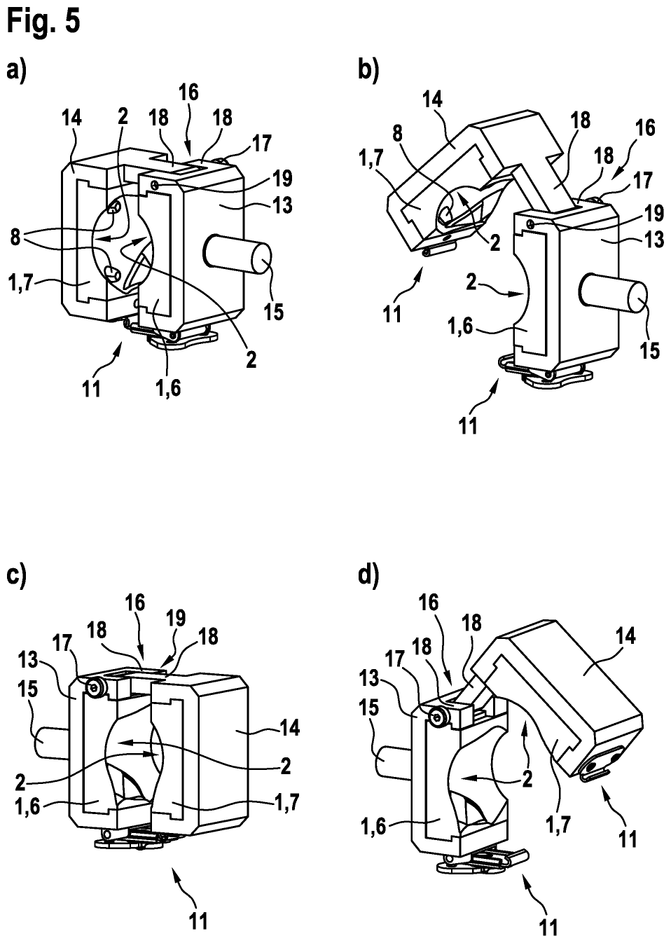

The illustrations of the holder 10 according to FIG. 5 show the holder 10 with positioning pin 8 in a) closed position and b) open position and without positioning pin 8 in c) closed position and d) open position,

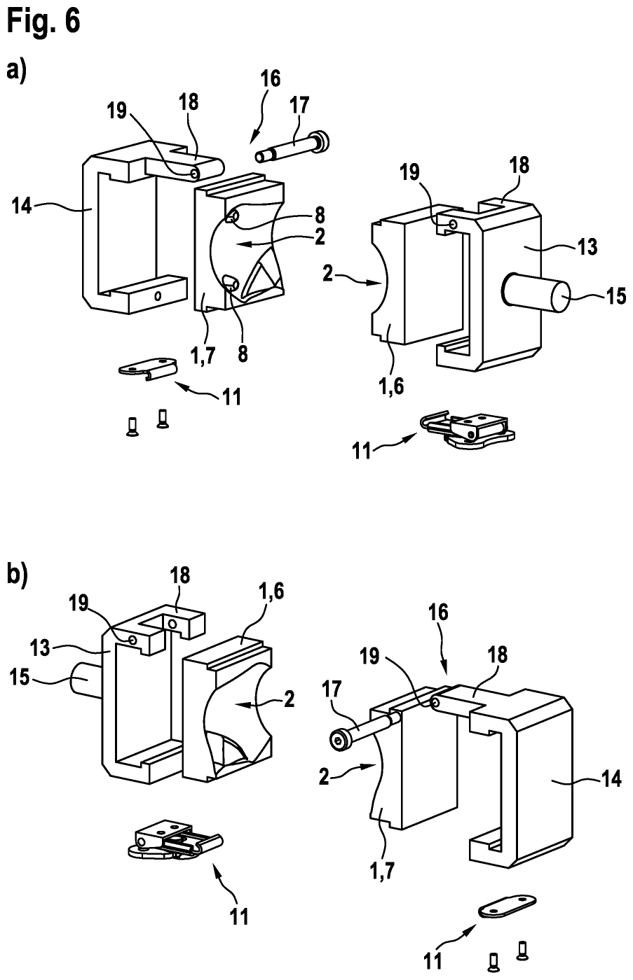

FIG. 6 shows a further exploded view of the holder 10 with positioning pin 8 a) and without positioning pin 8 b),

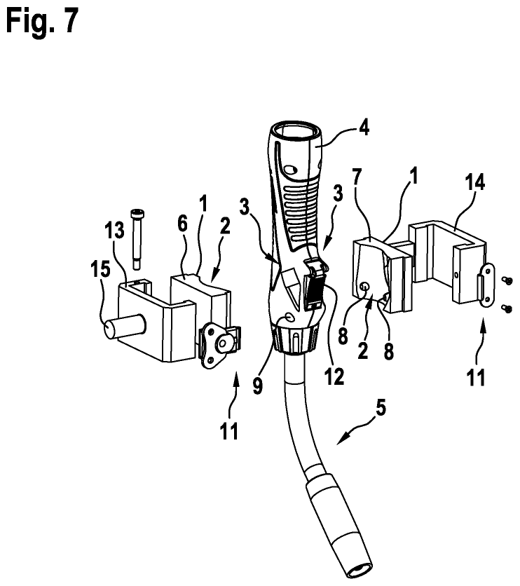

FIG. 7 shows another view of the holder 10 with hand-held torch 5 as shown in FIG. 1.

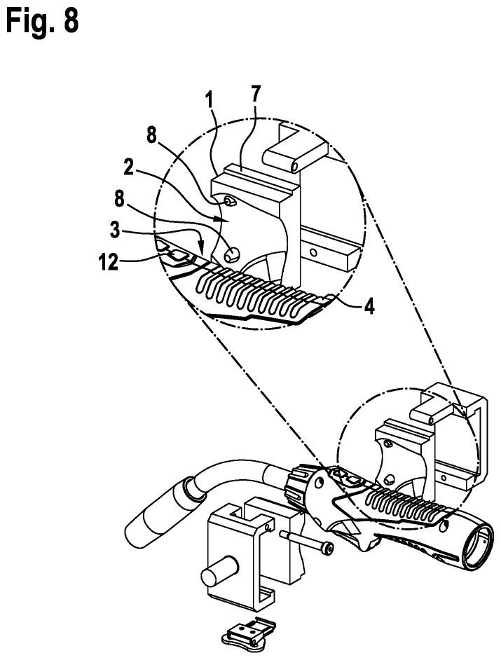

Finally, FIG. 8 shows a detailed view of the holder 10 with positioning pin 8.

In the present exemplary embodiment, the negative form 4 of the at least one securing means 1 is adapted to a handle 4 of the hand-held torch 5, which can also be seen in FIG. 1. This ensures reproducible positioning of the hand-held torch 5 for temporary automated applications, in particular to prevent it from twisting. This is because the user can set up the position of the hand-held torch 5, remove the hand-held torch 5 and then reinsert the torch 5 in exactly the same position that was previously set up without having to set it up again.

The securing means 1 according to the invention are formed in the present case from at least two sub-elements 6, 7, in particular from two half-shells which can be attached to the hand-held torch 5, as can be seen from FIGS. 1, 2, and 4. The half-shells of the holder ensure that the securing means 1 are easy to fit and interchangeable, and a single holder 1 can be used for different hand-held torches 5. This is because securing means 1, i.e., half-shells for securing the hand-held torch 5, can be easily adapted to different hand-held torch shapes.

At least one sub-element 6, 7 has a part of the negative form 4 of the hand-held torch 5. It is also conceivable that both sub-elements 6, 7 each have a negative form 4 of the hand-held torch 5.

As mentioned, the user can position the hand-held torch 5, remove it and then reinsert the torch 5 in exactly the same position without having to set it up again.

As can be seen from the figures, the hand-held torch 5 has a control element 12 for operating the hand-held torch 5 on the upper side of the torch and a further control element 12 on the lower side.

When the hand-held torch is secured, an operating element or at least one button of the hand-held torch is covered at least in regions in order to prevent unintentional operation. It does not matter whether the operating elements or buttons are located on the top and/or bottom of the hand-held torch.

In the present case, the operating element 12 or at least one button of the hand-held torch 5 is covered by the holder 10 or receptacles 13, 14, as can be seen in particular from FIGS. 3 and 4. It is also conceivable that the upper or lower operating elements 12 are covered by the securing part 1 or the closure 11.

In this way, switch-on protection is ensured to protect the hand-held torch 5 from manual misuse, as the holder 10 grips the hand-held torch 5 in the area of the upper and/or lower torch button 12. This prevents the operator from unintentionally triggering operating errors by hand when inserting the torch 5 into the holder 10. Even after the torch 5 has been inserted into the holder 10, the torch button(s) 12 are protected against unintentional triggering.

According to FIGS. 1, 3b, 5a and 5b, 6a, 7, and 8, at least one sub-element 6, 7 of the securing means 1 has an anti-rotation device. In the present exemplary embodiment, this is formed by at least one projection, in particular pin 8 or positioning pin, protruding from the surface of the sub-element 6, 7 of the securing means 1, which engages in a corresponding recess 9 or hole on the hand-held torch 5 when the sub-element 6, 7 is arranged on the hand-held torch 5.

In particular, generic hand-held torches 5 can have recesses 9 in the area of the handle shells of the handle 4, for example receptacles for fastening elements such as screws or rivets for connecting the handle shells of the hand-held torch 5 to each other or to other parts of the hand-held torch 5. These recesses 9, for example holes for screws or rivets, which are already present in known hand-held torches 5, can be used to accommodate the correspondingly designed projection, in this case the pin or positioning pin, in order to further improve the securing and also the accuracy of the positioning of the hand-held torch 5 in the holder 10.

In the present exemplary embodiment, the sub-elements 6, 7 are each held in a receptacle 13, 14 of the holder 10, as shown in particular in FIGS. 5 and 6.

The receptacles 13, 14 can be connected to one another by means of a hinge 16, shown in particular in FIGS. 1, 3, 4, 5, and 6, in order to be adjusted between the open position and the closed position. In the open position, the holder 10 can be placed on the hand-held torch 5 and then moved into the closed position to secure it. This adjustment can be easily realized with the hinge 16. The hinge 16 can be realized, for example, by a pin 17 forming the pivot or swivel axis of the hinge 16, which can be inserted into corresponding hinge elements 18 of the receptacles 13, 14 with through holes 19 to form the hinge 16. The hinge 16 can therefore be a simple plug-in connection. The two receptacles 13, 14 can be connected or secured together in the closed position by means of a closure 11.

FIGS. 3 a), 4 a), 5 a) and 5 c) show that these receptacles 13, 14 for the sub-elements 6, 7 are releasably connected or secured to one another by means of this closure 11, preferably a snap or butterfly closure, when the securing means 1 is arranged with the sub-elements 6, 7 on the hand-held torch 5. In particular, FIG. 3 a) shows the holder 10 with the sub-elements 6, 7 connected by means of a butterfly closure 11 in a closed position. FIG. 3 b) shows the holder 10, wherein the sub-elements 6, 7 are shown in an open position.

As mentioned, the sub-elements 6, 7 can be adapted to different types of hand-held torch. Depending on the use of a hand-held torch 5 in the holder 10, the sub-elements 6, 7 can be held in the holder 10 with the appropriate negative form 2 and secured in it by means of the closure 11.

FIG. 4 a) also shows the sub-elements 6, 7 in a closed position and FIG. 4 b) in an open position, wherein the views of FIGS. 3 a) and 3 b) also differ.

For better understanding, the holder 10 is shown in FIGS. 5 a) and c) without the hand-held torch in the closed position and in FIGS. 5 b) and d) in the open position. In the embodiment shown in FIGS. 5 a) and b), the positioning pin 8 is provided, which is missing in the embodiment shown in FIGS. 5 c) and d). This can also be seen in detail in FIGS. 6 a) and b), wherein the positioning pin 8 is provided in the holder 10 according to FIG. 6 a) and not according to FIG. 6 b).

The positioning pins 8, which engage in the corresponding recesses 9 on the hand-held torch 5 when the holder 10 is in the closed position, can also be seen in the detailed illustration in FIG. 8.

The sub-elements 6, 7 can essentially consist of plastic and/or metals. These can be self-hardening modeling compounds, for example. It is also possible to manufacture the sub-elements 6, 7 by injection molding or machining from plastics or metals.

For example, it is conceivable to use materials with shape memory, in particular self-hardening materials, to produce the negative form. These materials can be used to easily produce a large number of sub-elements 6, 7, each of which fits a specific hand-held torch 5.

In the present case, the hand-held torch 5, in particular the handle 3 of the hand-held torch 5, has a non-rotationally symmetrical design.

The figures also show a fastening element 15 arranged on the holder 10 in the form of a bolt, which is used to connect the holder 10 to other elements of the welding device.

This pin 15 is used to hold and fasten the welding tractor or another device or machine which guides the hand-held torch 5 for automated or semi-automated use or to which the hand-held torch 5 is fastened. In addition to the design, functionally identical or functionally similar holder designs, such as with a ball joint, are also conceivable.

### REFERENCE NUMERALS

1 Securing means

2 Negative form

3 Outer contour

4 Handle

5 Hand-held torch

6 Sub-element

7 Sub-element

8 Projection

9 Recess

10 Hand-held torch holder

11 Closure

12 Control element or button

13 Receptacle

14 Receptacle

15 Fastening element

16 Hinge

17 Push-in bolts

18 Hinge element

19 Through-hole

1. A holder (10) for a hand-held torch (5), comprising:
a securing means (1) for releasably securing the hand-held torch (5), the securing means (1) having at least in regions a negative form (2) of the hand-held torch (5) for reproducibly positioning the hand-held torch (5) in the holder (10), and the securing means (1) being adapted, at least in regions, to the outer contour (3) of the hand-held torch (5) when the hand-held torch (5) is secured.

2. The holder (10) according to claim 1, wherein the negative form (2) of the at least one securing means (1) is adapted to a handle (4) of the hand-held torch (5).

3. The holder (10) according to claim 1. wherein the securing means (1) is formed from at least two sub-elements (6, 7) which can be attached to the hand-held torch (5), and wherein at least one sub-element (6, 7) in each case has a part of the negative form (4) of the hand-held torch (5).

4. The holder (10) according to claim 1, wherein when the hand-held torch (5) is secured by the securing means (1), an operating element (12) or at least one button of the hand-held torch (5) is covered at least in regions in order to prevent unintentional operation of the hand-held torch (5).

5. The holder (10) according to claim 4, wherein the operating element (12) or at least one button of the hand-held torch is covered by the holder (10) or the securing means (1) or a closure (11) or a receptacle (13, 14).

6. The holder (10) according to claim 1. wherein at least one sub-element (6, 7) of the securing means (1) has at least one projection (8), projecting from the surface of the sub-element (6, 7) of the securing means (1), which, when the sub-element (6, 7) is arranged on the hand-held torch (5), engages in a corresponding recess (9) on the hand-held torch (5).

7. The holder (10) according to claim 1. wherein the sub-elements (6, 7) are each held in a receptacle (13, 14) of the holder (10).

8. The holder (10) according to claim 7, wherein the receptacles (13, 14) are pivotably connected to one another by a hinge (16) in order to be moved between an open position, in which the holder (10) can be attached to or on the hand-held torch (5), and a closed position, in which the holder (10) is secured to the hand-held torch (5).

9. The holder (10) according to claim 8, wherein the hinge (16) is formed from hinge elements (18) which are arranged in each case on the receptacles (13, 14) and in which a plug pin (17) forming the pivot or swivel axis engages.

10. The holder (10) according to claim 7. wherein the receptacles (13, 14) for the sub-elements (6, 7), when the securing means (1) is arranged with the sub-elements (6, 7) on the hand-held torch (5), can be releasably connected to one another by means of a snap-in connection or a screw connection or a closure (11).

11. The holder (10) according to claim 1. wherein the sub-elements (6, 7) consist essentially of plastic and/or of a self-hardening kneading compound and/or of metals.

12. A hand-held torch (5) with a holder (10) according to claim 1.

13. The hand-held torch (5) according to claim 12, wherein the handle (3) of the hand-held torch (5) is designed to be non-rotationally symmetrical.

14. A holder for a hand-held torch, comprising:
two half-shells configured to be releasably attached to the hand-held torch, wherein at least one half-shell is shaped to receive at least a portion of the outer contour of the hand-held torch for reproducibly positioning the hand-held torch in the holder.

15. The holder according to claim 14, wherein, when the hand-held torch is secured by the half shells of the holder, an operating element or at least one button of the hand-held torch is covered at least in regions in order to prevent unintentional operation of the hand-held torch.

16. The holder according to claim 14, wherein the half shells are each held in a respective receptacle of the holder, and wherein the receptacles are pivotably connected to one another by a hinge in order to be moved between an open position, in which the holder can be attached to or installed on the hand-held torch, and a closed position, in which the holder is secured to the hand-held torch.

17. The holder according to claim 16, wherein the receptacles for the half shells are releasably connected to one another by a snap-in connection or a snap-in closure or a screw connection or a butterfly closure.

18. A hand-held torch with the holder according to claim 14.

19. The hand-held torch according to claim 18, wherein the handle of the hand-held torch is designed to be non-rotationally symmetrical.
